(19) United States
(12) Patent Application Publication
(10) Pub. No.: US 2025/0082971 A1
(43) Pub. Date: Mar. 13, 2025

(54) ADVANCED WILDFIRE IGNITION PREVENTION AND NOTIFICATION

(71) Applicant: Sentient Technology Holdings, LLC, Wichita, KS (US)

(72) Inventors: Mirrasoul J. MOUSAVI, San Jose, CA (US); Timothy Robert FIGURA, Walnutport, PA (US); Giridhar IYER, Sunnyvale, CA (US); Robert KARSCHNIA, McKinney, TX (US)

(21) Appl. No.: 18/829,071

(22) Filed: Sep. 9, 2024

Related U.S. Application Data
(60) Provisional application No. 63/581,488, filed on Sep. 8, 2023.

(51) Int. Cl. A62C 3/02; H02J 3/00

(52) U.S. Cl. CPC A62C 3/02; H02J 3/0012

(57) ABSTRACT

Disclosed are approaches for advanced wildfire ignition prevention and notification. In one embodiment, a fire analysis and mitigation system includes a power grid including a plurality of configurable reclosers on feeders to a plurality of geographic areas. The system further includes a computing environment configured to analyze operational data for the power grid to detect a disturbance in operation of the power grid, analyze environmental data associated with the plurality of geographic areas, and reconfigure at least one recloser among the plurality of configurable reclosers based at least in part on the disturbance and the environmental data.

### CROSS-REFERENCE TO RELATED APPLICATIONS

This application claims the benefit of, and priority to, U.S. Provisional Patent Application No. 63/581,488, entitled “ADVANCED WILDFIRE IGNITION PREVENTION AND NOTIFICATION,” and filed on Sep. 8, 2023, which is incorporated herein by reference in its entirety.

### BACKGROUND

Electrical power grids include interconnected networks for the delivery of electricity from power stations and substations to end users. Among other components, an electrical power grid can include one or more power generation stations, transmission lines, electrical substations, and electric power distribution systems including distribution lines and transformers to end users.

Some power grids follow a feed design in which a power substation receives power from a transmission line network, the power is stepped down to a lower voltage with a transformer and sent to a bus. Feeders fan out from the bus in any number of directions to supply power to end users. The feeders can carry three-phase power and often extend along streets and into communities for power delivery.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a fire analysis and mitigation system. The fire analysis also includes a power grid. The power grid may include a plurality of configurable reclosers or reclosing circuit breakers on feeders to a plurality of geographic areas. The analysis also includes a computing environment configured to: analyze operational data for the power grid to detect a disturbance in operation of the power grid, analyze environmental data associated with the plurality of geographic areas, and reconfigure at least one recloser among the plurality of configurable reclosers based at least in part on the disturbance and the environmental data. Other embodiments of this aspect include corresponding computer systems, apparatus, and computer programs recorded on one or more computer storage devices, each configured to perform the actions of the methods.

Implementations may include one or more of the following features. The system where the environmental data may include at least one of: wind data, moisture data, or vegetation type data. The computing environment is configured to enable a wildfire prevention mode for the at least one recloser based at least in part on the environmental data and the disturbance. The computing environment is configured to exit a wildfire prevention mode for the at least one recloser in response to determining that the environmental data indicates a wildfire risk below a threshold. The disturbance is detected based at least in part on signals generated by the plurality of line sensors. The computing environment is further configured to generate a notification of the disturbance indicating one or more identified feeder segments. At least some of the plurality of configurable reclosers are gang-operated using peer-to-peer communication. At least some of the plurality of configurable reclosers are on feeder segments that serve fifty customers or less. Reconfiguring the at least one recloser further may include adjusting an overcurrent threshold for disconnection. Implementations of the described techniques may include hardware, a method or process, or computer software on a computer-accessible medium.

One general aspect includes a computer-implemented method for preventing wildfires caused by a power grid. The computer-implemented method also includes analyzing operational data for the power grid to detect a disturbance in operation of the power grid, the power grid may include a plurality of configurable reclosers on feeders to a plurality of geographic areas. The method also includes analyzing environmental data associated with the plurality of geographic areas. The method also includes reconfiguring at least one recloser among the plurality of configurable reclosers based at least in part on the disturbance and the environmental data. Other embodiments of this aspect include corresponding computer systems, apparatus, and computer programs recorded on one or more computer storage devices, each configured to perform the actions of the methods.

Implementations may include one or more of the following features. The computer-implemented method where the environmental data may include at least one of: wind data, moisture data, or vegetation type data. The computer-implemented method may include enabling a wildfire prevention mode for the recloser(s) based at least in part on the environmental data and the disturbance. The computer-implemented method may include exiting a wildfire prevention mode for the recloser(s) in response to determining that the environmental data indicates a wildfire risk below a threshold. The computer-implemented method may include detecting the disturbance based at least in part on signals generated by a plurality of line sensors distributed among the feeders on the power grid. The computer-implemented method may include generating a notification of the disturbance indicating one or more identified feeder segments. At least some of the plurality of configurable reclosers are gang-operated using peer-to-peer communication. At least some of the plurality of configurable reclosers are on feeder segments that serve fifty customers or less. Reconfiguring recloser(s) further may include adjusting a time period for reconnecting power service after a disconnection. Analyzing the operational data further may include performing waveform analytics on the operational data to classify the disturbance into a particular category of a plurality of categories. Implementations of the described techniques may include hardware, a method or process, or computer software on a computer-accessible medium.

One general aspect includes a non-transitory computer-readable medium storing instructions executable in a computing environment for preventing wildfires caused by a power grid. The non-transitory computer-readable medium storing instructions executable also includes analyzing operational data for the power grid to detect a disturbance in operation of the power grid, the power grid may include a plurality of configurable reclosers on feeders to a plurality of geographic areas. The executable also includes analyzing environmental data associated with the plurality of geographic areas. The executable also includes reconfiguring at least one recloser among the plurality of configurable reclosers based at least in part on the disturbance and the environmental data. Other embodiments of this aspect include corresponding computer systems, apparatus, and computer programs recorded on one or more computer storage devices, each configured to perform the actions of the methods.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example networked electrical grid environment according to various examples described herein.

FIG. 2 is a flowchart illustrating one example of functionality implemented as portions of the networked electrical grid environment of FIG. 1 according to various embodiments of the present disclosure.

### DETAILED DESCRIPTION

As noted above, electrical power grids include interconnected networks for the delivery of electricity from power stations and substations to end users. The embodiments described herein are directed to the large-scale deployment of electrical reclosers and an analytics platform for grid monitoring and control of the reclosers. The large-scale deployment of the reclosers facilitates the ability to implement powerline safety settings, such as enhanced powerline safety settings (EPSS), at a more granular scale. As examples, single or multi-phase reclosers can be installed on feeder lines supplying fewer than 100 customers or end users, fewer than 50, or even smaller numbers of users. The reclosers can be installed at a higher density in distribution circuits supplying power to High Fire Threat Districts (HFTD), to help avoid fire hazards as one example, although higher densities of reclosers can be installed in any area.

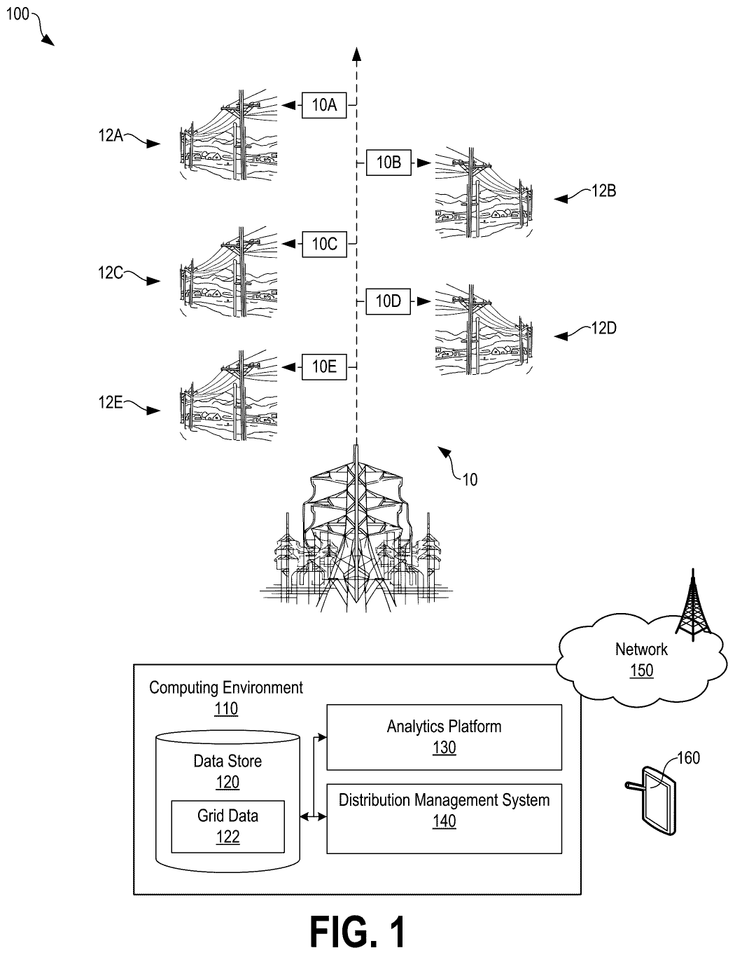

Turning to the drawings, FIG. 1 illustrates an example networked electrical grid environment 100 (“environment 100”) according to various examples described herein. The environment 100 includes a power grid 10 that supplies power to a number of different geographic areas 12A-12D, a computing environment 110, a network 150, and client devices 160.

The power grid 10 is representative in FIG. 1. In practice, the power grid 10 may include any number of transmission lines, sub-transmission lines, substations, feeder lines, transformers, power sensors, and related infrastructure. Each of the geographic areas 12A-12D is representative of a relatively small geographic area in which customers or end users receive power.

As shown in FIG. 1, the power grid 10 includes reclosers 10A-10E, among possibly many others (not shown). The distribution and arrangement of the reclosers 10A-10E is provided as a representative example in FIG. 1. In practice, the power grid 10 may include any number of reclosers, and a large-scale deployment of reclosers, including the reclosers 10A-10E and others, can be relied upon by the embodiments. The reclosers 10A-10E may be any recloser that is able to receive remote open or close commands. In normal usage, reclosers sense the fault current and react to an actual fault event. For wildfire prevention, that is too late, as the fault caused by failing equipment or vegetation contact may have already started a fire. As will be described, grid disturbances are used as an early indication of faults developing, and reclosers can be operated before, or in anticipation of, a fault.

Although not shown in FIG. 1, the power grid 10 may also include a number of power sensors, such as line sensors, installed at various locations. The power sensors are configured to and capable of detecting, measuring, and storing data related to the operation of the power grid 10, such as current and voltage or e-field measurements, frequency and phase measurements, and other operational information related to the power grid 10. Each of the power sensors is also configured to communicate with the computing environment 110 over the network 150. The power sensors can transfer the data related to the operation of the power grid 10 to the computing environment 110, for further processing by the computing environment 110. In some cases, one or more of the reclosers 10A-10E may also be capable of detecting, measuring, and storing data related to the operation of the power grid 10. The reclosers 10A-10E can also communicate such data to the computing environment 110 over the network 150.

Each of the reclosers 10A-10E can be embodied as a single or a multi-phase recloser. The reclosers 10A-10E are embodied as electro-mechanical switches and are capable of connecting and disconnecting power to and from the end users or customers within the geographic areas 12A-12D. The reclosers 10A-10E are designed to sense faults, disturbances, interrupts, and other operational issues related to the distribution of power to the areas 12A-12D and automatically disconnect power service in certain cases. As described in further detail below, each of the reclosers 10A-10E includes electrical components for the operation as an automatic electric switch and can also include one or more processors, memory devices, network interfaces, and other components to facilitate the operations described herein.

The reclosers 10A-10E can be installed on feeder lines for the supply of electric power to the areas 12A-12D. The areas 12A-12D can be associated with the supply of power to fewer than 100 customers or end users, fewer than 50, or even smaller numbers of users. Overall, the reclosers 10A-10E can be installed at a higher density in the power grid 10 as compared to other power grids and conventional installations. In some cases, each of the areas 12A-12D can be an HFTD or an area in which power distribution disturbances are more likely to occur due to weather, environmental conditions (e.g., higher wind, dense trees, falling branches, etc.), or for other reasons. The areas 12A-12D can also be areas in which fire or wildfire conditions are more likely to occur.

The reclosers 10A-10E according to the embodiments can be programmed to operate based on certain settings and monitor for faults, disturbances, and other issues according to the settings. As one example, the recloser 10A can be configured to disconnect service to the area 12A based on a predetermined threshold of overcurrent to the area 12A. The recloser 10A can also be configured to reconnect and restore power service to the area 12A after a period of time. The recloser 10A can be configured to disconnect and reconnect power any number of times on the basis of a range of criteria. The recloser 10A can also be configured to detect a permanent fault and disconnect power without reconnection. As described in further detail below, the overall operation of the reclosers 10A-10E can be directed by the computing environment 110. Thus, the reclosers 10A-10E can include network interfaces for data communication with the computing environment 110 and the client devices 160 over the network 150.

The computing environment 110 can be embodied as one or more computers, computing devices, or computing systems. The computing environment 110 can include one or more computing devices arranged, for example, in one or more server or computer banks. The computing device or devices can be located at a single installation site or distributed among different geographical locations. The computing environment 110 can include a plurality of computing devices that together embody a hosted computing resource, a grid computing resource, or other distributed computing arrangement. In some cases, the computing environment 110 can be embodied as an elastic computing resource where an allotted capacity of processing, network, storage, or other computing-related resources varies over time. The computing environment 110 can also be embodied, in part, as certain functional or logical (e.g., computer-readable instruction) elements or modules as described herein.

The network 150 can include the Internet, intranets, extranets, wide area networks (WANs), local area networks (LANs), wired networks, wireless networks, cable networks, satellite networks, other suitable networks, or any combinations thereof. As one example, the computing environment 110, the client devices 160, and the reclosers 10A-10E can be communicatively coupled to one or more public or private cellular networks (e.g., GSM, GPRS, EDGE, UMTS, HSPA, CDMA, SMS, 3G, 4G, 5G, NB-IoT, LPWAN, etc.), WiFi networks, satellite networks, or other suitable networks and, in some cases, to the Internet for communication of data among each other. Although not shown in FIG. 1, the network 150 can also include communicative connections to any number and type of network hosts or devices, such as website servers, file servers, cloud computing resources, databases, data stores, or any other network or computing architectures. In the environment 100, the computing environment 110, the client devices 160, the reclosers 10A-10E, and other devices can communicate data among each other using any suitable network transfer protocol or interconnect framework.

The client devices 160 are representative of one or more client devices. The client devices 160 can be embodied as any computing devices, processing circuits, or processor based devices or systems, including those in the form of desktop computers, laptop computers, tablet computers, personal digital assistants, cellular telephones, or wearable computing devices, among other example computing devices and systems. The client devices 160 can include various peripheral devices or components. The peripheral devices can include input or communications devices or modules, such as keyboards, keypads, touch pads, touch screens, microphones, cameras, wireless communications modules (e.g., Wi-Fi, BLUETOOTH®, etc.), buttons, switches, or sensors. The client devices 160 can execute one or more applications for interfacing with the computing environment 110 and, in some cases, the reclosers 10A-10E.

As shown in FIG. 1, the computing environment 110 includes a data store 120, an analytics platform 130, and a distribution management system 140 (also “DMS 140”). A DMS 140 for a power utility may be a comprehensive platform designed to monitor, manage, and optimize the operation of the electrical distribution network. The DMS 140 may integrate real-time data from various parts of the grid, including substations, transformers, and feeder lines, providing operators with a detailed view of power flows, load conditions, and equipment status. The DMS 140 may enhance the reliability and efficiency of the distribution network by enabling real-time decision-making, such as rerouting power during outages, managing load imbalances, and automating switching operations. The DMS 140 may support advanced applications like fault detection, isolation, and restoration (FDIR), voltage optimization, and load forecasting. By improving situational awareness and automating processes, the DMS 140 may facilitate efficient energy delivery, reduces downtime during faults, and helps the utility meet demand while maintaining grid stability and resilience.

In some embodiments, the DMS 140 may be absent, and functions described such as reconfiguring reclosers may be performed by a SCADA system. A SCADA system in a power utility may manage and monitor the entire power generation, transmission, and distribution network in real-time. The SCADA system may allow operators to oversee the flow of electricity from power plants to substations and ultimately to consumers, ensuring reliable and efficient operation. Through a centralized control room, the SCADA system may continuously collect data from sensors and devices across the grid, such as voltage, current, and power flows, enabling operators to quickly detect and respond to issues like equipment failures, overloads, or outages. Additionally, the system facilitates remote control of circuit breakers, transformers, and other critical equipment, helping maintain grid stability and optimize energy distribution. The SCADA system may also record historical data for performance analysis, improving decision-making and ensuring compliance with safety and regulatory standards.

In some embodiments, the DMS 140 may comprise an Advanced Distribution Management System (ADMS), which is an integrated software platform used by power utilities to enhance the management, monitoring, and optimization of their distribution networks. Building upon the functionalities of traditional DMS, ADMS combines real-time data analytics, advanced grid automation, and predictive capabilities to provide a more comprehensive view of the grid. The ADMS may enable intelligent decision-making for fault detection, isolation, and service restoration, optimizing voltage and reactive power, and managing distributed energy resources (DERs) like solar and wind. By incorporating demand response, outage management, and grid resilience features, ADMS may allow utilities to handle the complexities of modern grids with more renewable energy and decentralized generation. The ADMS may improve operational efficiency, minimize outages, reduce energy losses, and ensure a reliable, stable power supply while supporting the transition to a more flexible and sustainable energy network.

The data store 120 can store a range of operational data, computer-executable code, and other data for processing by the computing environment 110. As shown, the data store 120 includes grid data 122. The grid data 122 can include data related to the operation of the power grid 10. For example, as described above, the power grid 10 includes power sensors capable of detecting, measuring, and storing data related to the operation of the power grid 10, such as current and voltage/e-field measurements, frequency and phase measurements, and other operational information related to the power grid 10. The power sensors can communicate the data related to the operation of the power grid 10 to the computing environment 110, and the computing environment 110 can store the operational data as the grid data 122 for further analysis and processing.

The analytics platform 130 can be embodied as a process, application, or service capable of reviewing and analyzing the grid data 122. As an example, the analytics platform 130 can analyze the grid data 122 for the purpose of detecting disturbances, faults, or other power delivery operation issues of the power grid 10. The analytics platform 130 can also conduct waveform analytics on the grid data 122. The analytics can be performed on the on the grid data 122 to classify disturbances, faults, and other power-distribution issues into certain categories, for example, and for related purposes.

In some cases, the analytics platform 130 can analyze the grid data 122 with respect to a range of environmental conditions associated with the areas 12A-12D. The analytics platform 130 can be configured to monitor the environmental conditions in each of the areas 12A-12D over time, such as the wind conditions, the level of humidity or precipitation, and related environmental conditions in each of the areas 12A-12D over time. The analytics platform 130 can also account for geographic features or characteristics among the areas 12A-12D, such as regions of thick or heavy vegetation (e.g., trees, etc.), dry or arid climates, regions including valleys, hills, or mountains, and other geographic features and characteristics.

The analytics platform 130 is also configured in some cases to provide advanced notification of wildfires or the conditions for wildfires based on the review of the grid data 122 and related environmental conditions. As an example, the analytics platform 130 may identify a higher level of wildfire risk when certain disturbances are detected on the power grid 10 and the environmental conditions are conducive to wildfires (e.g., dry climates, areas with heavy vegetation, etc.). The analytics platform 130 can provide a notification of such high risk conditions and, in some cases, provide direction to the DMS 140 for mitigation of the risk. Risk factors can include high wind, high temperature, dry vegetation, growing season status, plush vegetation, and so on.

The analytics platform 130 can, in some cases, direct the DMS 140 based on the analysis performed on the grid data 122. For example, based on the detection of disturbances, faults, or other issues, based on the environmental conditions associated with the areas 12A-12D, or based on some combination thereof, the analytics platform 130 can direct the DMS 140 to configure or reconfigure settings on one or more of the reclosers 10A-10E. This may have the effect of sacrificing some power grid reliability for wildfire safety when wildfire risk is very high. Thus, the computing environment 110 is configured to analyze data related to the power grid 10 and, in some cases, configure or reconfigure the operational settings of the reclosers 10A-10E based on the operation of the power grid 10 in real time.

The DMS 140 can configure settings on each of the reclosers 10A-10E, respectively, depending on the analysis performed by the analytics platform 130. The DMS 140 can also configure settings on each of the reclosers 10A-10E, respectively, over time and based on the real time analysis performed by the analytics platform 130. As an example, the DMS 140 can perform a targeted reconfiguration of certain settings on a group of the reclosers 10A-10E based on a certain combination of environmental and detected conditions. Because the reclosers 10A-10E are installed at a relatively higher density, the operation of the power grid 10 can be controlled a more granular level. The reclosers 10A-10E and operation of the power grid can be tailored for each of the areas 12A-12D, respectively, based on the analysis performed by the analytics platform 130.

Both the analytics platform 130 and the DMS 140 can operate continuously over time to review, monitor, and analyze the grid data 122. The analytics platform 130 and the DMS 140 can also operate outside of the fire season, to help eliminate sources of ignitions (e.g., equipment failure, vegetation/tree contact, etc.) as soon as they appear in the grid data 122 and before leading to a permanent and/or temporary fault. Overall, the computing environment 110 provides a closed-loop fault and fire mitigation control solution between the sensors and the reclosers 10A-10E.

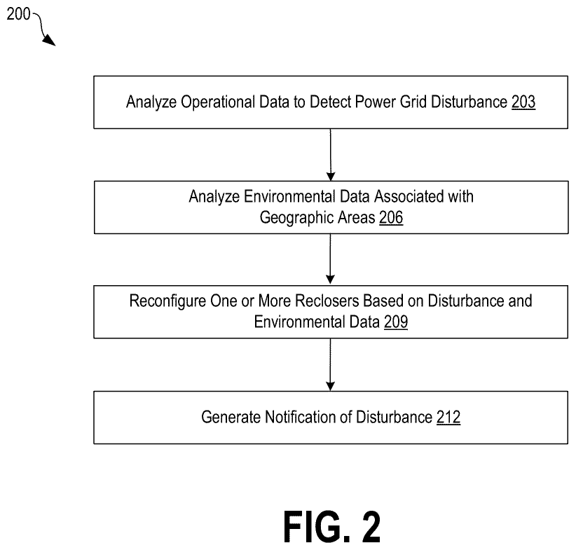

Referring next to FIG. 2, shown is a flowchart 200 that provides one example of the operation of a portion of the networked electrical grid environment 100 according to various embodiments. It is understood that the flowchart 200 of FIG. 2 provides merely an example of the many different types of functional arrangements that may be employed to implement the operation of the portion of the networked electrical grid environment 100 as described herein. As an alternative, the flowchart of FIG. 2 may be viewed as depicting an example of elements of a method implemented in the computing environment 110 (FIG. 2) according to one or more embodiments.

Beginning with box 203, the electrical grid environment 100 analyzes operational data to detect a power grid disturbance. The power grid includes multiple configurable reclosers on feeders to a plurality of geographic areas. The reclosers may be in network communication with the electrical grid environment 100 to report operational parameters and status and to receive commands. In some cases, a recloser may be on a feeder that supplies power to fewer than fifty customers. In this way, the reclosers can provide fine-grained control of the power grid.

In some embodiments, some of the reclosers may be gang-operated using peer-to-peer communication. In other words, activation of one recloser may trigger activation of another adjacent or nearby recloser through communication between the reclosers. The power grid is also instrumented with networked sensors that report signals of grid parameters (e.g., current, voltage, e-field, reactive power, etc.) for use in detecting disturbances. The analysis may include performing waveform analytics on the operational data to classify the disturbance into a particular category of multiple categories. In some embodiments, a machine learning model may be trained to classify the disturbance from the operational data based at least in part on historical data associating grid operational parameters with wildfires. The machine learning model may be trained to recognize different patterns in data, including those that indicate early signs of equipment failures and vegetation coming into contact with power lines.

In box 206, the electrical grid environment 100 analyzes environmental data associated with the plurality of geographic areas. For example, the environmental data may include wind data, moisture data, and/or vegetation type data.

In box 209, the electrical grid environment 100 reconfigures one or more reclosers based at least in part on the disturbance and the environmental data. In one embodiment, the electrical grid environment 100 may enable a wildfire prevention mode for the recloser(s) based at least in part on the environmental data and the disturbance. For example, the environmental data may indicate that an area is suffering from drought conditions and especially susceptible to wildfire, and this may be taken into account in aggressively configuring the reclosers to cut power in response to disturbances. The electrical grid environment 100 may cause the recloser(s) to exit a wildfire prevention mode in response to determining that the environmental data indicates a wildfire risk below a threshold. In one embodiment, the recloser is configured by adjusting an overcurrent threshold for disconnection (e.g., making the threshold lower in conditions of high wildfire risk, or making the threshold higher in conditions of low wildfire risk). In one embodiment, the recloser is configured to adjust a time period for reconnecting power service after a disconnection (e.g., making the time period longer in conditions of high wildfire risk, or shorter in conditions of low wildfire risk).

In box 212, the electrical grid environment 100 generates a notification of the disturbance, potentially indicating the impacted feeder segments. The notification may also indicate any actions taken to reconfigure or operate the reclosers. The notification may provide advanced notification potentially days before a potential ignition to reduce a power company's crew patrol time. Thereafter, the operation of the flowchart 200 ends.

The computing environment 110 can include at least one processing circuit. Such a processing circuit can include, for example, one or more processors and one or more storage or memory devices coupled to a local interface. The local interface can include, for example, a data bus with an accompanying address/control bus or any other suitable bus structure. Similarly, each of the client devices 160 can include at least one processing circuit. Such a processing circuit can include, for example, one or more processors and one or more storage or memory devices coupled to a local interface.

The storage or memory devices can store data or components that are executable by the processors of the processing circuit. For example, the analytics platform 130, the DMS 140, and/or other components can be stored in one or more storage devices and be executable by one or more processors in the computing environment 110. Similarly, any applications executed by the client devices 160 can be stored in one or more storage devices of the client devices 160 and be executable by one or more processors of the client devices 160.

The analytics platform 130, the DMS 140, and other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, and/or programmable logic devices (e.g., field-programmable gate array (FPGAs), and complex programmable logic devices (CPLDs)).

Additionally, each of the reclosers 10A-10E can also include one or more processors, memory devices, network interfaces, and other components to facilitate the operations described herein. The operations of the reclosers 10A-10E can be directed by hardware, by software, and by a combination thereof. To the extent embodied as hardware, the reclosers 10A-10E can be implemented as circuits or state machines, one or more microprocessors, discrete logic circuits, ASICS, FPGAs, CPLDs, and other circuits.

Also, one or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein, including the analytics platform 130, the DMS 140, and other components, can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, terms such as “application,” “service,” “system,” “engine,” “module,” and so on can be used interchangeably and are not intended to be limiting.

The flowchart of FIG. 2 shows the functionality and operation of an implementation of portions of the networked electrical grid environment 100. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart of FIG. 2 shows a specific order of execution, it is understood that the order of execution may differ from that which is depicted. For example, the order of execution of two or more blocks may be scrambled relative to the order shown. Also, two or more blocks shown in succession in FIG. 2 may be executed concurrently or with partial concurrence. Further, in some embodiments, one or more of the blocks shown in FIG. 2 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

Therefore, the following is claimed:

1. A fire analysis and mitigation system, comprising:
a power grid comprising a plurality of configurable reclosers on feeders to a plurality of geographic areas; and
a computing environment configured to:
analyze operational data for the power grid to detect a disturbance in operation of the power grid;
analyze environmental data associated with the plurality of geographic areas; and
reconfigure at least one recloser among the plurality of configurable reclosers based at least in part on the disturbance and the environmental data.

2. The system of claim 1, wherein the environmental data comprises at least one of: wind data, moisture data, or vegetation type data.

3. The system of claim 1, wherein the computing environment is configured to enable a wildfire prevention mode for the at least one recloser based at least in part on the environmental data and the disturbance.

4. The system of claim 1, wherein the computing environment is configured to exit a wildfire prevention mode for the at least one recloser in response to determining that the environmental data indicates a wildfire risk below a threshold.

5. The system of claim 1, further comprising a plurality of line sensors distributed among the feeders on the power grid, wherein the disturbance is detected based at least in part on signals generated by the plurality of line sensors.

6. The system of claim 1, wherein the computing environment is further configured to generate a notification of the disturbance indicating one or more identified feeder segments.

7. The system of claim 1, wherein at least some of the plurality of configurable reclosers are gang-operated using peer-to-peer communication.

8. The system of claim 1, wherein at least some of the plurality of configurable reclosers are on feeder segments that serve fifty customers or less.

9. The system of claim 1, wherein reconfiguring the at least one recloser further comprises adjusting an overcurrent threshold for disconnection.

10. A computer-implemented method for preventing wildfires caused by a power grid, comprising:
analyzing operational data for the power grid to detect a disturbance in operation of the power grid, the power grid comprising a plurality of configurable reclosers on feeders to a plurality of geographic areas;
analyzing environmental data associated with the plurality of geographic areas; and
reconfiguring at least one recloser among the plurality of configurable reclosers based at least in part on the disturbance and the environmental data.

11. The computer-implemented method of claim 10, wherein the environmental data comprises at least one of: wind data, moisture data, or vegetation type data.

12. The computer-implemented method of claim 10, further comprising enabling a wildfire prevention mode for the at least one recloser based at least in part on the environmental data and the disturbance.

13. The computer-implemented method of claim 10, further comprising exiting a wildfire prevention mode for the at least one recloser in response to determining that the environmental data indicates a wildfire risk below a threshold.

14. The computer-implemented method of claim 10, further comprising detecting the disturbance based at least in part on signals generated by a plurality of line sensors distributed among the feeders on the power grid.

15. The computer-implemented method of claim 10, further comprising generating a notification of the disturbance indicating one or more identified feeder segments.

16. The computer-implemented method of claim 10, wherein at least some of the plurality of configurable reclosers are gang-operated using peer-to-peer communication.

17. The computer-implemented method of claim 10, wherein at least some of the plurality of configurable reclosers are on feeders that serve fifty customers or less.

18. The computer-implemented method of claim 10, wherein reconfiguring the at least one recloser further comprises adjusting a time period for reconnecting power service after a disconnection.

19. The computer-implemented method of claim 10, wherein analyzing the operational data further comprises performing waveform analytics on the operational data to classify the disturbance into a particular category of a plurality of categories.

20. A non-transitory computer-readable medium storing instructions executable in a computing environment for preventing wildfires caused by a power grid, wherein when executed the instructions cause the computing environment to at least:
analyze operational data for the power grid to detect a disturbance in operation of the power grid, the power grid comprising a plurality of configurable reclosers on feeders to a plurality of geographic areas;
analyze environmental data associated with the plurality of geographic areas; and
reconfigure at least one recloser among the plurality of configurable reclosers based at least in part on the disturbance and the environmental data.
